(19) United States
(12) Patent Application Publication
(10) Pub. No.: US 2026/0005271 A1
(43) Pub. Date: Jan. 1, 2026

(54) SYSTEMS AND METHODS FOR INITIALIZING A FUEL CELL (FC) USING SPLIT BATTERIES AND POWERING A LOAD

(71) Applicant: Toyota Motor Engineering & Manufacturing North America, Inc., Plano, TX (US)

(72) Inventor: Arlo Conrad Eitzer, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/757,914

(22) Filed: Jun. 28, 2024

(51) Int. Cl. H01M 8/04223; H01M 8/04029; H01M 8/04302; H01M 8/04701; H01M 8/04746

(52) U.S. Cl. CPC H01M 8/04268; H01M 8/04029; H01M 8/04302; H01M 8/04723; H01M 8/04768; H01M 8/04776

(57) ABSTRACT

Systems, methods, and other embodiments described herein relate to heating a startup battery within a battery system to rapidly initialize and start a fuel cell (FC). In one embodiment, a method includes triggering coolant flow using a startup battery that actuates controllable valves coupled to the startup battery, and the startup battery powers a FC and the startup battery is coupled to a heater and a running battery. The method also includes initiating the heater for a battery system to warm coolant using the startup battery, the battery system includes the startup battery and the running battery. The method also includes starting the FC with the startup battery, expanding the coolant flow, and switching on the running battery to power a load upon satisfaction of a threshold for charging the startup battery.

### TECHNICAL FIELD

The subject matter described herein relates, in general, to initializing a fuel cell (FC) during various temperature conditions, and, more particularly, to heating a startup battery within a battery system to initialize and startup the FC safely for powering a load.

### BACKGROUND

Systems seeking alternatives to powering a vehicle can involve using a fuel cell (FC). For example, the FC converts chemical energy stored in a fuel (e.g., hydrogen) directly into electricity through an electrochemical process. Hydrogen gas within an FC stack can be fed to an anode (i.e., a negative electrode) that triggers a catalytic reaction, splitting into protons and electrons. The protons pass through an electrolyte membrane to the cathode (i.e., a positive electrode). Meanwhile, the electrons are forced through an external circuit, generating electrical power for an electric motor that drives the vehicle. Byproducts of the electrochemical process are water vapor and heat, thereby making FCs environmentally friendly.

In various implementations, systems initializing an FC before startup using a battery can encounter difficulties and safety issues at reduced temperatures. Unlike combustion engines, the FC can demand a controlled environment and certain conditions to safely initiate and sustain the electrochemical process that generates electricity. Similarly, batteries experience reduced efficiency and capacity at reduced temperatures. The reduced capacity can lead to decreased power output that limits capabilities for providing the necessary energy for initialization. Furthermore, sustaining the electrochemical process can involve the FC outputting power to a load, such as charging the battery. However, the battery (e.g., a lithium-ion battery) has thermal conditions to satisfy at the reduced temperatures prior to safely accepting power and charging. In one approach, systems include heating elements, insulation, etc., that mitigate the effects of degraded temperatures. Still, this can delay and sometimes end initialization for a startup when heating is severely insufficient during frigid temperatures. Therefore, systems initializing an FC using a battery at a reduced temperature face challenges that cause startup delays and increase failure events.

### SUMMARY

In one embodiment, example systems and methods relate to heating a startup battery within a battery system to rapidly initialize and start a fuel cell (FC). In various implementations, systems generate heat for temperature control involving an FC using a galvanic pile, combustion, etc., particularly at reduced temperatures. However, these systems may run the FC at an inefficient rate for rapidly warming the system and completing initialization. Furthermore, initialization and startup can generate errors, fail, stall, etc., when the FC demands an output draw that is insufficient. The output draw can be charging a battery in an electric vehicle, powering a home appliance, etc. Furthermore, systems initializing and starting the FC using a battery (e.g., a high-voltage (HV) battery) at reduced temperatures encounter difficulties since the battery is able to discharge but exhibits charging capabilities that are limited until the battery is warmed. Thus, systems initializing an FC during reduced temperatures can face reduced efficiency and errors, such as when a battery has insufficient charge and discharge power for the FC.

Therefore, in one embodiment, an initiation system warms a startup battery having a reduced size within a battery system to startup a FC rapidly using the startup battery, such as when ambient temperatures are cold. Here, the battery system can have split, divided, portioned, etc., battery strings (e.g., lithium-ion battery, a nickel-cadmium battery, etc.) that include the startup battery and the running battery coupled on a bus. In particular, a size ratio between the startup battery and the running battery may be uneven such that the startup battery can quickly reach a threshold (e.g., a temperature, state-of-charge (SoC), etc.) for charging. In one approach, the initiation system commands a heater for the battery system to warm coolant using power from the startup battery. A command also allows warm coolant to flow towards the startup battery rather than the running battery, such as during environmental temperatures that are reduced. In this way, the startup battery reaches the threshold for charging sooner than the running battery through benefiting from the size ratio and the initiation system avoids additional time for heating the running battery. Thus, this allows the startup within a shorter timeframe as the FC has a source for drawing power through charging the startup battery.

Upon satisfaction of the threshold for charging, the initiation system starts the FC with the startup battery and the FC charges the startup battery using generated power initially pushed by the FC. Furthermore, the running battery connects to the bus associated with full operation of the FC. Accordingly, the initiation system hastens startup times for an FC during poor temperature conditions using a battery system having different sized batteries and heating a startup battery for accepting charge from the FC, thereby avoiding delays associated with heating the batteries.

In one embodiment, an initiation system for heating a startup battery within a battery system to rapidly initialize and start a FC is disclosed. The initiation system includes a memory storing instructions that, when executed by a processor, cause the processor to trigger coolant flow using a startup battery that actuates controllable valves coupled to the startup battery, and the startup battery powers a FC and the startup battery is coupled to a heater and a running battery. The instructions also include instructions to initiate the heater for a battery system to warm coolant using the startup battery, the battery system includes the startup battery and the running battery. The instructions also include instructions to start the FC with the startup battery, expand the coolant flow, and switch on the running battery to power a load upon satisfaction of a threshold for charging the startup battery.

In one embodiment, a non-transitory computer-readable medium for heating a startup battery within a battery system to rapidly initialize and start a FC and including instructions that when executed by a processor cause the processor to perform one or more functions is disclosed. The instructions include instructions to trigger coolant flow using a startup battery that actuates controllable valves coupled to the startup battery, and the startup battery powers a FC and the startup battery is coupled to a heater and a running battery. The instructions also include instructions to initiate the heater for a battery system to warm coolant using the startup battery, the battery system includes the startup battery and the running battery. The instructions also include instructions to start the FC with the startup battery, expand the coolant flow, and switch on the running battery to power a load upon satisfaction of a threshold for charging the startup battery.

In one embodiment, a method for heating a startup battery within a battery system to rapidly initialize and start a FC is disclosed. In one embodiment, the method includes triggering coolant flow using a startup battery that actuates controllable valves coupled to the startup battery, and the startup battery powers a FC and the startup battery is coupled to a heater and a running battery. The method also includes initiating the heater for a battery system to warm coolant using the startup battery, the battery system includes the startup battery and the running battery. The method also includes starting the FC with the startup battery, expanding the coolant flow, and switching on the running battery for powering a load upon satisfaction of a threshold for charging the startup battery.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an initiation system that is associated with controlling a startup battery within a battery system and a heating system to rapidly start a fuel cell (FC).

FIG. 3 illustrates one embodiment of the FC, the battery system, and a heater warming a startup battery and preparing the FC for startup.

FIG. 4 illustrates one embodiment of a method that is associated with initiating a heating system for the battery system using the startup battery and warming the startup battery for FC startup.

### DETAILED DESCRIPTION

Systems, methods, and other embodiments associated with heating a startup battery within a battery system to rapidly initialize and start a fuel cell (FC) are disclosed herein. In various implementations, systems powering loads using an FC encounter delays and errors during startup, particularly involving cold startup. For example, an electric vehicle (EV) having a high voltage (HV) battery to startup an FC encounters delays with preparing the HV battery for charging. Here, a startup procedure can involve coupling the HV battery to the FC for pulling power (e.g., discharge) from the HV battery and “jump” starting the FC. The startup procedure completes by having to output and push power (e.g., charge) towards the HV battery. However, the HV battery can accept power and charge upon meeting certain operation conditions (e.g., temperature). Waiting for the HV battery to satisfy operating conditions can become extended using a heater, excessive heat from the FC, etc. Wait times are especially extended during frigid weather. Thus, systems initializing and starting a FC have robustness challenges with battery systems, particularly during atypical weather and power pushing events.

Therefore, in one embodiment, an initiation system improves a startup time for an FC through a startup battery reaching operating conditions before an entire battery using intelligent coolant and battery management. Here, an entire battery can be a battery system (e.g., lithium-ion, nickel-cadmium, etc.) having the startup battery and a running battery coupled on a bus (e.g., a HV bus). The startup battery may be a subunit within the battery system that initializes the FC and receives charge initially pushed from the FC during and after FC startup. The FC, the startup battery, and the running battery may operate in a steady state and power a load after the FC startup.

In one approach, the startup battery to running battery size is comparatively reduced (e.g., a 1:10 ratio). In this way, the initiation system rapidly prepares for starting the FC. Upon startup preparation, the initiation system can trigger coolant flow and a controller to toggle controllable valves. The trigger can also involve the startup battery powering a heater that warms coolant for the battery system. In one approach, the initiation system uncouples the running battery from the bus for avoiding unsafe charging during FC startup. Also, the toggling causes a coolant valve to open and allow flow of the coolant towards the startup battery while avoiding the flow towards the running battery. In this way, the coolant (e.g., glycerin, water and glycerin, etc.) is concentrated towards the startup battery and increases operating temperature until a threshold that allows charging through power pushed by the FC.

Moreover, in one embodiment, the initiation system starts the FC with the startup battery and the startup battery draws pushed power from the FC during the startup. The startup battery can safely receive and charge using the pushed power as the threshold is met. Meanwhile, the initiation system saves startup times through avoiding charging the entire battery including the running battery. Furthermore, the initiation system can actuate controllable valves that allows coolant towards the running battery and couple the running battery to the bus. Accordingly, the initiation system increases safety and saves time associated with FC startup through a battery system that is optimized proportionally in size between a running battery and a startup battery.

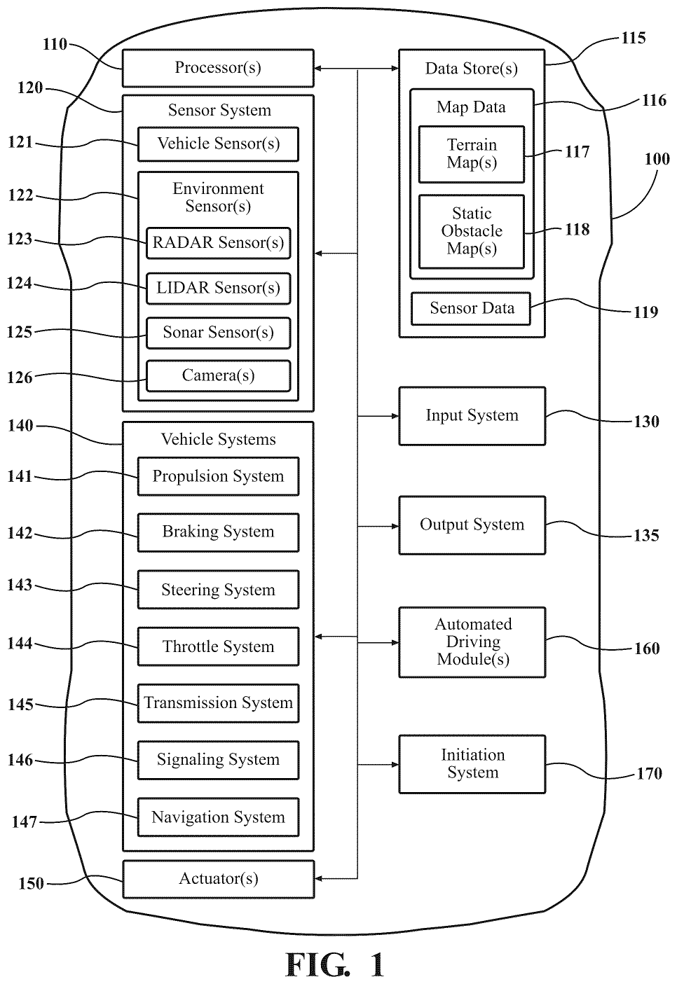

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an initiation system 170 uses road-side units (RSU), consumer electronics (CE), mobile devices, robots, drones, and so on that benefit from the functionality discussed herein associated with heating a startup battery within a battery system to rapidly initialize and start a FC. Furthermore, in one embodiment, the vehicle 100 is an EV, a HEV, a FC vehicle, etc., having a motor powered by an FC and a battery (e.g., a HV battery, a low voltage battery, etc.).

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances.

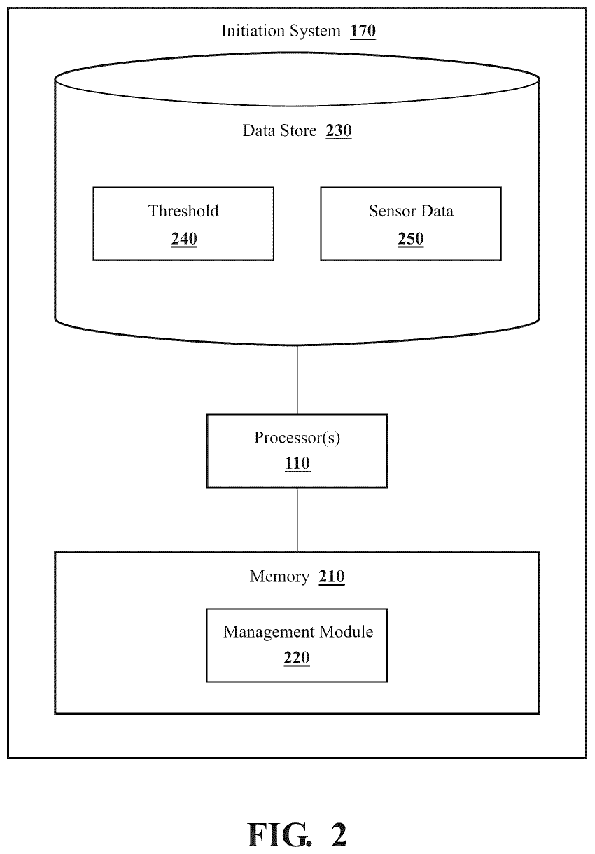

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an initiation system 170 that is implemented to perform methods and other functions as disclosed herein relating to heating a startup battery within a battery system that is optimally sized to rapidly initialize and start a FC.

With reference to FIG. 2, one embodiment of the initiation system 170 of FIG. 1 is further illustrated. The initiation system 170 is shown as including a processor(s) 110 from the vehicle 100 of FIG. 1. Accordingly, the processor(s) 110 may be a part of the initiation system 170, the initiation system 170 may include a separate processor from the processor(s) 110 of the vehicle 100, or the initiation system 170 may access the processor(s) 110 through a data bus or another communication path. In one embodiment, the initiation system 170 includes a memory 210 that stores a management module 220. The memory 210 is a random-access memory (RAM), a read-only memory (ROM), a hard-disk drive, a flash memory, or other suitable memory for storing the management module 220. The management module 220 is, for example, computer-readable instructions that when executed by the processor(s) 110 cause the processor(s) 110 to perform the various functions disclosed herein.

With reference to FIG. 2, the management module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the initiation system 170 and the management module 220, in one embodiment, acquire sensor data 250 that includes at least battery parameters, an operating temperature, a battery temperature, state-of-charge (SoC), discharge power, charge power, etc., associated with a battery system (e.g., a startup battery).

Accordingly, the initiation system 170, in one embodiment, controls the respective sensors to provide the data inputs in the form of the sensor data 250. Additionally, while the initiation system 170 is discussed as controlling the various sensors to provide the sensor data 250, in one or more embodiments, the initiation system 170 can employ other techniques to acquire the sensor data 250 that are either active or passive. For example, the initiation system 170 may passively sniff the sensor data 250 from a stream of electronic information provided by the various sensors to further components within the vehicle 100. Moreover, the initiation system 170 can undertake various approaches to fuse data from multiple sensors when providing the sensor data 250 and/or from sensor data acquired over a wireless communication link.

In one embodiment, the initiation system 170 includes a data store 230 that is a database. The database is, in one embodiment, an electronic data structure stored in the memory 210 or another data store and that is configured with routines executed by the processor(s) 110 for analyzing stored data, providing stored data, organizing stored data, and so on. Thus, in one embodiment, the data store 230 stores data used by the management module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. The data store 230 can further include threshold 240 representing an operating level that is relevant for operating the FC and batteries. For instance, the threshold 240 is temperature for a battery system, a starting battery, a running battery, etc., to satisfy before the FC can safely charge of the battery system and run a startup procedure. Similarly, the threshold 240 can be a weighted score for both a temperature and a SoC for a starting battery to satisfy before the FC can safely charge the starting battery during the startup procedure.

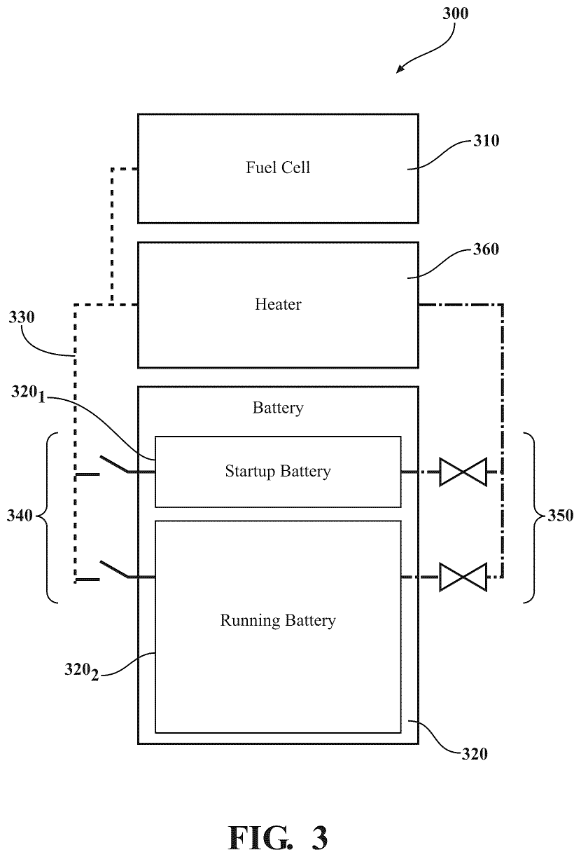

Now turning to FIG. 3, one embodiment of a FC, a battery system, and a heater warming a startup battery and preparing a FC system 300 for startup is illustrated. For the examples given, a FC startup may include a battery system 320 initially powering a FC 310 and preparing components for a startup procedure. The FC 310 starts up by pulling power from the battery system 320, generating electricity, and pushing output power during initial cycling. As previously explained, the FC 310 can safely start through charging the battery system 320 with the output power pushed during the initial cycling.

In FIG. 3, the FC system 300 has the FC 310 and the battery system 320 (e.g., lithium-ion battery, a nickel-cadmium battery, etc.). The FC 310 converts chemical energy stored in a fuel (e.g., hydrogen) into electricity through an electrochemical process. Fuel within an FC stack can be fed to an anode (i.e., negative electrode) that triggers a catalytic reaction, splitting into protons and electrons. The protons travel through an electrolyte membrane to a cathode (i.e., a positive electrode). The FC 310 generates electricity for the vehicle 100 through the electronics being forced through an external circuit coupled to various systems, such the vehicle systems 140.

Moreover, the battery system 320 may be a HV battery, a low-voltage battery, etc., that has a startup battery 3201 and a running battery 3202. The battery system 320 can initialize, start, and run the FC 310. Here, the battery system 320 splits, divides, etc., battery components rather than having cells coupled in series, parallel, etc., within a unit. In particular, the startup battery 3201 and the running battery 3202 are battery strings having a size ratio that is uneven. The startup battery 3201 and the running battery 3202 can together, individually, etc., couple to a bus 330 (e.g., a HV bus) using switches 340. For instance, the size ratio between the startup battery 3201 and the running battery 3202 is 1:10, 1:4, etc., for a battery capacity (e.g., 200 kWh) and cell count (e.g., 96). In another approach, the battery system 320 can comprise any size ratio and capacity for powering a load.

Additionally, the startup battery 3201 and the running battery 3202 receive coolant warmed by the heater 360 through one or more controllable valves 350. For instance, the one or more controllable valves 350 can be ball valves, three-way valves, etc. In various implementations, the FC 310 and the battery system 320 operate at a reduced temperature, SoC, etc., that allows discharging but not charging demanded during FC startup. As such, the FC system 300 expedites FC startup through the startup battery 3201 reaching the threshold 240 for charging sooner than the battery system 320 entirely through leveraging size differences. In this way, the initiation system 170 avoids additional time and delays for heating the running battery 3202.

Moreover, the initiation system 170, in one embodiment, is further configured to perform additional tasks beyond controlling the respective sensors to acquire and provide the sensor data 250. For example, the initiation system 170 and the management module 220 include instructions that cause the processor 110 to trigger coolant flow by the startup battery 3201 actuating the controllable valves 350 coupled to the startup battery 3201. Here, the startup battery 3201 can selectively power a FC before, after, etc., startup. The initiation system 170 initiates the heater 360 for the battery system 320 to warm coolant using power from the startup battery 3201. The coolant flows through a radiator, coils, etc., of the heater 360 during warming. Thus, the startup battery 3201 powers the FC 310 and the heater 360 during initialization and selectively thereafter.

Upon satisfaction of the threshold 240 for charging the startup battery 3201, the initiation system 170 and/or the management module 220 can start the FC 310 with the startup battery 3201, expand the coolant flow, and switch on the running battery 3202. In this way, the battery system 320 can safely start the FC 310 by allowing pushed output power to charge the startup battery 3201. As such, the FC 310 and the battery system 320 can power a load that includes one of the vehicle 100, a building, a home, and an electric vehicle while reducing startup times.

Regarding further details, in various implementations, the initiation system 170 triggers and commands the startup battery 3201 to supply power for toggling and controlling the controllable valves 350 (e.g., coolant valves). In particular, the controllable valves 350 actuate (e.g., open, close, etc.) such that coolant (e.g., cooling water, a water and glycerin mix, etc.) flows towards the startup battery 3201 rather than the running battery 3202. In this way, the startup battery 3201 prepares for accepting charge from the FC 310 during FC startup. Here, the heater 360 can warm the coolant using discharged power from the startup battery 3201 and the startup battery 3201 rapidly reaches the threshold 240 (e.g., above zero Celsius). For instance, the heater 360 is a device that having elements that warm the coolant. In one approach, the startup battery 3201 uses ambient air that is heated with the heater 360, excessive heat from the FC 310, etc., for heating up. Irrespective of the charging approach, the startup battery 3201 reduces time associated with preparing the FC system 300 for startup and full operation through directly heating a subunit of the battery system 320 rather than across existing battery cells that increases initialization times.

Warming the startup battery 3201 to the threshold 240 before accepting a charging push can further involve toggling the switch 340 for optimization. For example, the startup battery 3201 is coupled with the bus 330 while the running battery 3202 is uncoupled. In this way, the FC system 300 warms the startup battery 3201 quickly while protecting the running battery 3202 from inadvertently accepting charging from the FC 310. In one approach, inadvertent charging occurs when the running battery 3202 does not satisfy the threshold 240 with a battery temperature below zero Celsius and a SoC at 99%.

Eventually, the startup battery 3201 reaches the threshold 240 for accepting charge resulting from starting the FC 310. The initiation system 170 and/or management module 220 start the FC 310 that generates a power push. The startup battery 3201 quickly and safely absorbs the power push during the FC startup. In various implementations, pushing the power involves converting HV electricity from the FC 310 to low voltage when the startup battery 3201 is a low-voltage battery. Regarding duration, the power push may continue until reaching a steady state by the FC 310 involving consistently powering a load and drawing power from the startup battery 3201 and the running battery 3202.

In one approach, the initiation system 170 and/or management module 220 couple the running battery 3202 to the bus 330 and supply power to the FC 310 and the heater 360 when startup completion is imminent. The management module 220 can also switch the controllable valves 350 so that the coolant flows towards the running battery 3202 for warming to the threshold 240. In this way, the running battery 3202 can accept charge similar to the starting battery 3201 during normal operation of the FC system 300 while supplying running power. In another example, the management module 220 closes the controllable valves 350, uncouples the startup battery 3201, and couples the running battery 3202 to the bus 330. Accordingly, the running battery 3202 operates after startup and the startup battery 3201 runs during startup, thereby increasing battery life through reducing cycling of the startup battery 3201.

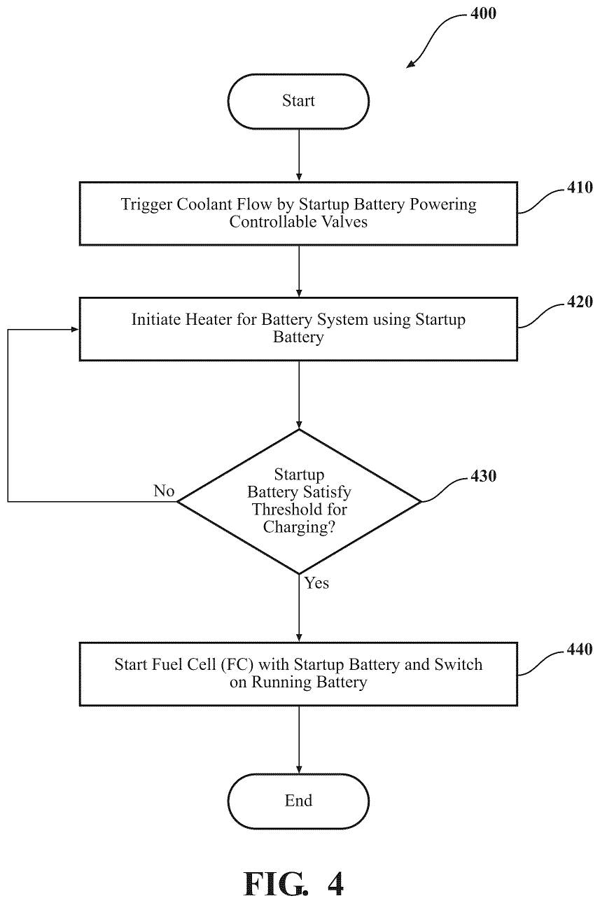

Concerning FIG. 4, one embodiment of a method 400 that is associated with initiating a heating system for a battery system using a startup battery and warming the startup battery for FC startup is illustrated. FIG. 4 illustrates a flowchart of a method 400 that is associated with heating the startup battery within the battery system to rapidly initialize and start the FC. Method 400 will be discussed from the perspective of the initiation system 170 of FIGS. 1 and 2. While the method 400 is discussed in combination with the initiation system 170, it should be appreciated that the method 400 is not limited to being implemented within the initiation system 170 but is instead one example of a system that may implement the method 400.

At 410, the initiation system 170 triggers coolant flow using the startup battery powering controllable valves that are coupled to a heater and the startup battery. Here, the battery system is operating at reduced temperatures, poor conditions for charging, cold temperatures, etc., and the controllable valves control coolant that warms cells within the battery system. The controllable valves can be ball valves, three-way valves, etc., actuated using power from the battery system.

In one approach, warm coolant flows to the startup battery rather than the running battery through opening the controllable valve to the startup battery. Meanwhile, the controllable valve may close for the running battery to focus the warm coolant towards the startup battery. This quickly warms the startup battery for accepting charge during FC startup. Furthermore, the startup battery and the running battery are battery strings having a size ratio that is uneven (e.g., 1:10, 1:4, etc.). In this way, the initiation system 170 expedites FC startup through the startup battery reaching the threshold 240 for charging sooner than the battery system entirely by benefiting from battery sizing. In other words, the split, divided, etc., battery system avoids additional time for heating the running battery that is more sizable than the startup battery, thereby increasing system performance.

At 420, the initiation system 170 initiates the heater for the battery system using the startup battery. In one approach, the heater warms coolant (e.g., water and glycerin mixture) that flows through a radiator, coils, etc. In another approach, excessive heat from the FC, heated air, etc., warms the coolant. Furthermore, at 430 the warm coolant flows through the valves to the startup battery until satisfying the threshold 240 for charging the startup battery. The threshold 240 can be an operating level that is relevant for operating the FC and batteries. For instance, the threshold 240 is temperature for a battery system, a running battery, etc., to satisfy before the FC can safely charge the starting battery during startup. As previously explained, the threshold 240 can be a weighted score for both a temperature, SoC, etc., for the starting battery to satisfy.

At 440, the management module 220 starts the FC with the startup battery and switches on the running battery upon satisfying the threshold 240 for charging the starting battery. The FC initially generates a power push that the startup battery safely accepts and absorbs. In this way, the initiation system 170 saves startup times through avoiding charging the entire battery including the running battery. In one approach, the initiation system 170 couples the running battery to the FC and the heater with a startup completion that is forthcoming. The management module 220 can also switch the controllable valves so that the coolant flows towards the running battery for warming to the threshold 240. Accordingly, the initiation system 170 efficiently starts up a FC using a startup battery that is a minimal size compared to a running battery and reduces warming time for charging, particularly when operating during frigid conditions.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the initiation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the initiation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the initiation system 170, and/or the automated driving module(s) 160 can be operatively connected to communicate with the various vehicle systems 140 and/or individual components thereof. For example, the processor(s) 110, the initiation system 170, and/or the automated driving module(s) 160 can be in communication to send and/or receive information from the various vehicle systems 140 to control the movement of the vehicle 100. The processor(s) 110, the initiation system 170, and/or the automated driving module(s) 160 may control some or all of the vehicle systems 140.

The processor(s) 110, the initiation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the initiation system 170, and/or the automated driving module(s) 160 can control the direction and/or speed of the vehicle 100. The processor(s) 110, the initiation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the initiation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An initiation system comprising:
a memory storing instructions that, when executed by a processor, cause the processor to:
trigger coolant flow using a startup battery that actuates controllable valves coupled to the startup battery, and the startup battery powers a fuel cell (FC) and the startup battery is coupled to a heater and a running battery;
initiate the heater for a battery system to warm coolant using the startup battery, the battery system includes the startup battery and the running battery; and
upon satisfaction of a threshold for charging the startup battery, start the FC with the startup battery, expand the coolant flow, and switch on the running battery to power a load.

2. The initiation system of claim 1, wherein the instructions to start the FC further include instructions to:
toggle a switch on a bus to couple with the startup battery and uncouple the running battery, the startup battery and the running battery are coupled on the bus; and
draw power by the startup battery for the charging from the FC.

3. The initiation system of claim 2, wherein the instructions to trigger the coolant flow further include instructions to:
communicate a command for the controllable valves that causes the coolant flow towards the startup battery rather than the running battery, and the coolant has an increased temperature.

4. The initiation system of claim 2 further including instructions to:
upon reaching a steady state of the FC, uncouple the startup battery and couple the running battery to the bus.

5. The initiation system of claim 2 further including instructions to:
actuate the controllable valves to allow the coolant flow towards the startup battery and the running battery.

6. The initiation system of claim 1, wherein the threshold is one of an operating temperature, a state-of-charge (SoC), a charge level, and a discharge level associated with the startup battery.

7. The initiation system of claim 1, wherein the startup battery and the running battery are battery strings having a size ratio that is uneven.

8. The initiation system of claim 1, wherein the startup battery is one of a low voltage battery and a high voltage battery, and the load is one of a vehicle, a building, a home, and an electric vehicle.

9. A non-transitory computer-readable medium comprising:
instructions that when executed by a processor cause the processor to:
trigger coolant flow using a startup battery that actuates controllable valves coupled to the startup battery, and the startup battery powers a fuel cell (FC) and the startup battery is coupled to a heater and a running battery;
initiate the heater for a battery system to warm coolant using the startup battery, the battery system includes the startup battery and the running battery; and
upon satisfaction of a threshold for charging the startup battery, start the FC with the startup battery, expand the coolant flow, and switch on the running battery to power a load.

10. The non-transitory computer-readable medium of claim 9, wherein the instructions to start the FC further include instructions to:
toggle a switch on a bus to couple with the startup battery and uncouple the running battery, the startup battery and the running battery are coupled on the bus; and
draw power by the startup battery for the charging from the FC.

11. The non-transitory computer-readable medium of claim 10, wherein the instructions to trigger the coolant flow further include instructions to:
communicate a command for the controllable valves that causes the coolant flow towards the startup battery rather than the running battery, and the coolant has an increased temperature.

12. The non-transitory computer-readable medium of claim 10 further including instructions to:
upon reaching a steady state of the FC, uncouple the startup battery and couple the running battery to the bus.

13. A method comprising:
triggering coolant flow using a startup battery that actuates controllable valves coupled to the startup battery, and the startup battery powers a fuel cell (FC) and the startup battery is coupled to a heater and a running battery;
initiating the heater for a battery system to warm coolant using the startup battery, the battery system includes the startup battery and the running battery; and
upon satisfaction of a threshold for charging the startup battery, starting the FC with the startup battery, expanding the coolant flow, and switching on the running battery for powering a load.

14. The method of claim 13, wherein starting the FC further includes:
toggling a switch on bus to couple with the startup battery and uncouple the running battery, the startup battery and the running battery are coupled on the bus; and
drawing power by the startup battery for the charging from the FC.

15. The method of claim 14, wherein triggering the coolant flow further includes:
communicating a command for the controllable valves that causes the coolant flow towards the startup battery rather than the running battery, and the coolant has an increased temperature.

16. The method of claim 14 further comprising:
upon reaching a steady state of the FC, uncoupling the startup battery and coupling the running battery to the bus.

17. The method of claim 14 further comprising:
actuating the controllable valves to allow the coolant flow towards the startup battery and the running battery.

18. The method of claim 13, wherein the threshold is one of an operating temperature, a state-of-charge (SoC), a charge level, and a discharge level associated with the startup battery.

19. The method of claim 13, wherein the startup battery and the running battery are battery strings having a size ratio that is uneven.

20. The method of claim 13, wherein the startup battery is one of a low voltage battery and a high voltage battery, and the load is one of a vehicle, a building, a home, and an electric vehicle.
